(19) United States
(12) Patent Application Publication
(10) Pub. No.: US 2014/0009693 A1
(43) Pub. Date: Jan. 9, 2014

(54) PICO PROJECTOR

(71) Applicants: SINTAI OPTICAL (SHENZHEN) CO., LTD., Shenzhen City (CN); ASIA OPTICAL INTERNATIONAL LTD., Tortola (GB)

(72) Inventor: Lin-Chieh Kao, Taichung (TW)

(73) Assignees: ASIA OPTICAL INTERNATIONAL LTD., Tortola (GB); SINTAI OPTICAL (SHENZHEN) CO., LTD., Shenzhen City (CN)

(21) Appl. No.: 13/769,870

(22) Filed: Feb. 19, 2013

(30) Foreign Application Priority Data
Jul. 3, 2012 (TW) 101123811

(51) Int. Cl. H04N 5/74

(52) U.S. Cl. CPC H04N 5/7475
USPC 348/789

(57) ABSTRACT

A pico projector includes a transmission connector, a projector body and a transmission wire body. The projector body includes an accommodation portion utilized to accommodate the transmission connector. The transmission wire body is extended from an interior of the projector body to the transmission connector.

### BACKGROUND OF THE INVENTION

1. Field of the Invention

The invention relates to a pico projector configured with a transmission connector and a transmission wire body.

2. Description of the Related Art

With pico projectors being provided with conveniences of operation and storage and being much smaller and lighter than conventional projectors, the pico projectors are becoming more and more evaluated in the market.

The pico projector can be classified into two types, an embedded type and an independent type. The embedded type pico projector, which is majorly utilized to integrate with mobile devices, is capable of being embedded in the mobile device (e.g., mobile phones and digital cameras) and received energy supplied from a battery unit of the mobile device. The independent type pico projector is externally connected to the mobile device via a transmission wire so as to display picture or video files stored in the mobile devices.

However, it is inconvenient to the user when bringing and storing the transmission wire.

### BRIEF SUMMARY OF THE INVENTION

In view of the above-described difficulties, the invention provides a pico projector configured with a transmission connector and a transmission wire body, thereby eliminating the inconveniences of bringing and storing the transmission wire to the user.

The pico projector of the invention includes a transmission connector, a projector body and a transmission wire body. The projector body includes an accommodation portion utilized to accommodate the transmission connector. The transmission wire body is extended from an interior of the projector body to the transmission connector.

In one aspect of the invention, the accommodation portion is a concave slot configured on an outer surface of the projector body.

In another aspect of the invention, the accommodation portion matches the transmission connector in shape, so that the transmission connector can be accommodated in the accommodation portion.

In another aspect of the invention, the accommodation portion matches the transmission wire body in shape, so that the transmission wire body can be accommodated in the accommodation portion.

Alternatively, the accommodation portion can be a chamber configured in the projector body.

The pico projector of the invention further comprises a wire-rolling mechanism configured in the projector body and connected to the transmission wire body.

In another aspect of the invention, the accommodation portion is configured with an opening thereon to allow the transmission wire body to pass therethrough.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows that a transmission connector and a transmission wire body are disengaged from an accommodation portion in accordance with a first embodiment of a pico projector of the invention;

FIG. 2 shows that the transmission connector and the transmission wire body are received in the accommodation portion in accordance with the first embodiment of the pico projector of the invention;

FIG. 3 shows that a transmission connector is disengaged from an accommodation portion in accordance with a second embodiment of a pico projector of the invention;

FIG. 4 shows that the transmission connector is received in the accommodation portion in accordance with the second embodiment of the pico projector of the invention.

### DETAILED DESCRIPTION OF THE INVENTION

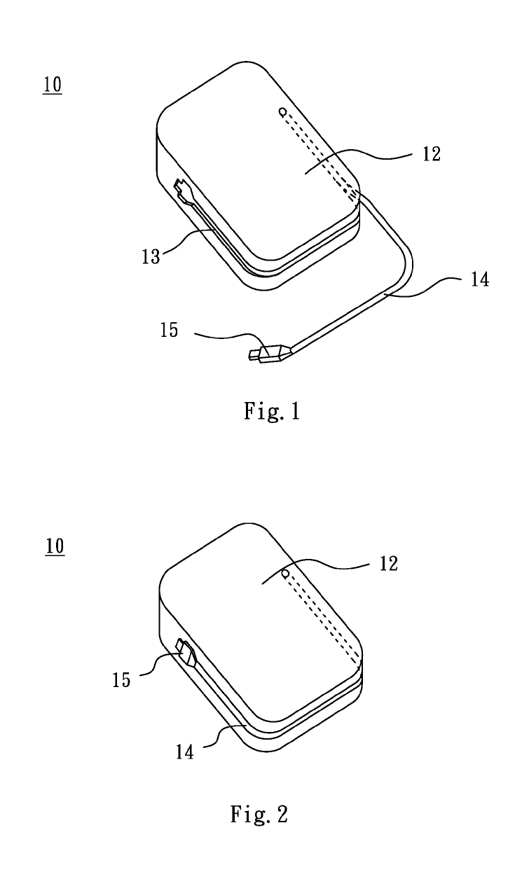

Referring to FIGS. 1 and 2, in a first embodiment of the invention, a pico projector 10 comprises a projector body 12, a transmission wire body 14 and a transmission connector 15, in which the transmission wire body 14 extended from an interior of the projector body 12 is connected to the transmission connector 15. The transmission connector 15 is, for example, a universal serial bus (USB) connector.

An accommodation portion 13 is configured on an outer surface of the projector body 12. In this embodiment, the accommodation portion 13 is a concave slot, and the accommodation portion 13 matches the transmission connector 15 and the transmission wire body 14 in shape. When the pico projector 10 is not in use, the transmission connector 15 and the transmission wire body 14 can be fixedly accommodated in the accommodation portion 13 of the projector body 12 with a slight interference provided therebetween, to avoid disengagement. To use the pico projector 10, the transmission wire body 14 and the transmission connector 15 is disengaged from the accommodation portion 13 of the projector body 12 by applying an external force thereon, and the transmission connector 15 is connected to other external devices such as mobile phones, digital cameras, multimedia players, notebook computers and game players, so that picture or video files stored in the external devices can be transmitted to the pico projector 10 for displaying.

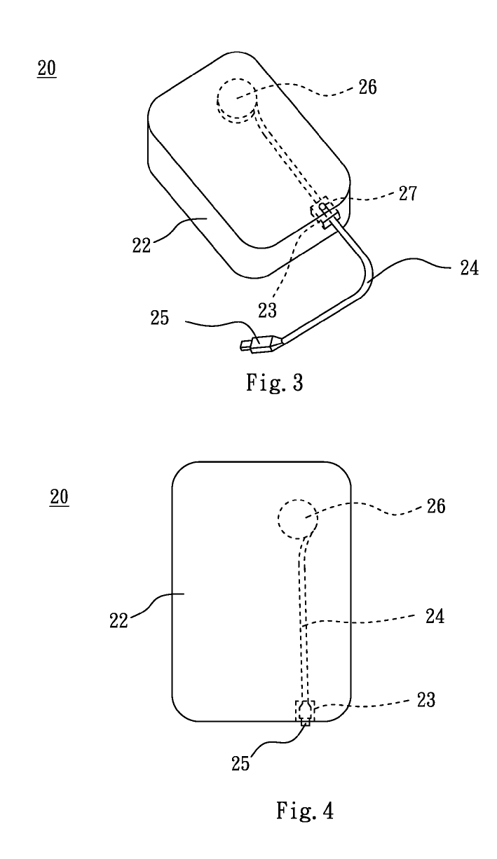

Referring to FIGS. 3 and 4, in a second embodiment of the invention, a pico projector 20 comprises a projector body 22, a wire-rolling mechanism 26 configured in the projector body 22, a transmission connector 25, and a transmission wire body 24 having two ends respectively connected to the wire-rolling mechanism 26 and the transmission connector 25. The transmission connector 25 is, for example, a universal serial bus (USB) connector.

An accommodation portion 23 is configured in the projector body 22 to accommodate the transmission connector 25. In this embodiment, the accommodation portion 23 is a chamber, and the accommodation portion 23 is configured with an opening 27 thereon to allow the transmission wire body 24 to pass therethrough. The transmission wire body 24 is wound on the wire-rolling mechanism 26. To use the pico projector 20, a user pulls the transmission connector 25 out of the projector body 22 from the accommodation portion 23, and the transmission wire body 24 is pulled out of the wire-rolling mechanism 26 in relation with the transmission connector 25, in which the length of the transmission wire body 24 pulled out of the wire-rolling mechanism 26 is adjusted by the user in accordance with the requirement. Then, the transmission connector 25 is connected to other external devices such as mobile phones, digital cameras, multimedia players, notebook computers and game players, so that picture or video files stored in the external devices can be transmitted to the pico projector 20 for displaying.

In the first embodiment, the transmission wire body 14 of the pico projector 10 has a fixed length. In the second embodiment, the transmission wire body 24 of the pico projector 20 has an adjustable length in accordance with the requirement.

In conclusion, the invention provides a pico projector configured with a transmission connector and a transmission wire body, thereby eliminating the inconveniences of bringing and storing the transmission wire to the user in conventional skills. Further, the transmission connector and the transmission wire body can be conveniently collected without occupying additional space, when the pico projector is not in use. Accordingly, bringing and storing the transmission connector and the transmission wire body is quite convenient to the user.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A pico projector, comprising:
a transmission connector;
a projector body comprising an accommodation portion utilized to accommodate the transmission connector; and
a transmission wire body extended from an interior of the projector body to the transmission connector.

2. The pico projector as claimed in claim 1, wherein the accommodation portion is a concave slot configured on an outer surface of the projector body.

3. The pico projector as claimed in claim 2, wherein the accommodation portion matches the transmission connector in shape, to accommodate the transmission connector.

4. The pico projector as claimed in claim 2, wherein the accommodation portion matches the transmission wire body in shape, to accommodate the transmission wire body.

5. The pico projector as claimed in claim 1, wherein the accommodation portion is a chamber configured in the projector body.

6. The pico projector as claimed in claim 5 further comprising a wire-rolling mechanism configured in the projector body and connected to the transmission wire body.

7. The pico projector as claimed in claim 5, wherein the accommodation portion is configured with an opening thereon to allow the transmission wire body to pass therethrough.
